(19) United States
(12) Patent Application Publication
(10) Pub. No.: US 2019/0212420 A1
(43) Pub. Date: Jul. 11, 2019

(54) LIDAR System Having a Movable Fiber

(71) Applicant: Blickfeld GmbH, Munich (DE)

(72) Inventor: Florian Petit, Munich (DE)

(73) Assignee: Blickfeld GmbH, Munich (DE)

(21) Appl. No.: 16/327,022

(22) PCT Filed: Aug. 7, 2017
(86) PCT No.: PCT/EP2017/069911

§ 371 Date: Feb. 21, 2019

(30) Foreign Application Priority Data
Aug. 23, 2016 (DE) 102016010236.5

(51) Int. Cl. G01S 7/481; G01S 7/484; G01S 17/10

(52) U.S. Cl. CPC G01S 7/4818; G01S 17/10; G01S 7/484; G01S 7/4817

(57) ABSTRACT

An arrangement comprises a fiber-shaped element with a first end and a second end. The arrangement also comprises a fixing which fixes the fiber-shaped element to a fixing position. An actuator is designed to move the first end of the fiber-shaped element opposite the fixing position. In some examples a LIDAR system is designed in order to carry out a scanned distance measuring of objects in the surroundings of the arrangement based on the light.

### TECHNICAL AREA

Different embodiments relate to an arrangement which comprises a fiber-shaped element and an actuator which is arranged to move a first end of the fiber-shaped element opposite a fixed position of the fiber-shaped element. In various embodiments the arrangement also comprises a LIDAR system which is arranged for carrying out a scanned distance measurement of objects in the surroundings of the arrangement based on laser light.

### BACKGROUND

The distance measuring of objects is desirable in various fields of technology. For example, it can be desirable in conjunction with applications of autonomous driving to recognize objects in the surroundings of motor vehicles and in particular to determine a distance to the objects.

A technology for the distance measuring of objects is the so-called LIDAR technology (Engl. Light Detection and Ranging; sometimes also LADAR). In it, pulsed laser light is sent out from an emitter. The objects in the surroundings reflect the laser light. These reflections can subsequently be measured. A distance to the objects can be determined by determining the runtime of the laser light.

In order to recognize the objects in the surroundings in a spatially resolved manner, it can be possible to scan the laser light. This can recognize different objects in the surroundings as a function of the radiated angle of the laser light.

However, traditional, spatially resolved LIDAR systems have the disadvantage that they can be relatively expensive, heavy, maintenance-intensive and/or large.

Typically, a scan mirror is used in LIDAR systems which can be brought into different positions. An accuracy with which the position of the scan mirror can be determined typically limits the accuracy of the spatial resolution of the LIDAR measuring. Moreover, the scan mirror is often large, and the adjusting mechanism can be maintenance-intensive and/or expensive.

Technologies are known from Leach, Jeffrey H., Stephen R. Chinn and Lew Goldberg “Monostatic all-fiber scanning LADAR system”, Applied Optics 54.33 (2015): 9752-9757 for carrying out a scanned LIDAR measuring with an adjustable curvature of a light fiber. Corresponding technologies are also known from Mokhtar, M.H.H. and R.R.A. Syms, “Tailored fiber waveguides for precise two-axis Lissajous scanning). Optics Express 23.16 (2015): 20804-20811.

Such technologies have the disadvantage that the curvature of the light fiber is comparatively limited. Moreover, it can be difficult to implement a lens which avoids a beam divergence of laser light exiting from the end of the light fiber.

### SUMMARY

Therefore, there is a need for improved technologies for measuring the distance of objects in the surroundings of an arrangement. In particular, there is a need for such technologies which eliminate at least some of the above-cited limitations and disadvantages.

This problem is solved by the features of the independent claims. The features of the dependent claims define embodiments.

A device comprises a flexible, fiber -shaped element with a first end and a second end. The device also comprises a fixing which fixes the fiber-shaped element to a fixing position. The device also comprises a deflection unit which is stationarily connected to the first end of the fiber-shaped element and is arranged for deflecting incident laser light. The device also comprises at least one actuator which is designed to move the fiber-shaped element in the area between the fixing position and the first end. The device also comprises a laser light source which is designed to radiate primary laser light onto the deflection unit. An optical path of the primary laser light to the deflection unit does not run through the fiber-shaped element. An angle between an optical path of the first laser light and the central axis of the fiber-shaped element is in the range of 120°-240°, optionally in the range of 150°-210° in a rest position of the fiber-shaped element.

A device comprises a flexible, fiber-shaped element with a first end and a second end. The device also comprises a fixing which fixes the fiber-shaped element to a fixing position between the first end and the second end. The device also comprises a deflection unit which is stationarily connected to the first end of the fiber-shaped element and is designed to deflect incident laser light. The device also comprises at least one actuator which is designed to move the fiber-shaped element in the area between the fixing position and the first end. The device also comprises a laser light source which is designed to radiate primary laser light onto the deflection unit. The device also comprises a LIDAR system which is designed to carry out a scanned distance measuring of objects in the surroundings of the arrangement based on the primary laser light. An optical path of the primary laser light to the deflection unit does not run through the fiber.

In an example, a method comprises the moving of a fiber-shaped element in the area between a fixing position of the fiber-shaped element to a fixing and between a first end of the fiber-shaped element. A deflection unit is stationarily connected to the first end of the fiber-shaped element. The method also comprises the irradiating of the deflection unit with primary laser light. The optical path of the laser light does not run through the fiber -shaped element. The method can optionally comprise the carrying out of a scanned distance measuring of objects.

The above-explained features and features described in the following can be used not only in the corresponding, explicitly explaining combinations but also in other combinations or in isolation without departing from the protective scope of the present invention.

### BRIEF DESCRIPTION OF THE FIGURES

FIG. 1A schematically illustrates an arrangement designed to carry out a scanned distance measuring of objects in the surroundings of the arrangement according to different embodiments, wherein the arrangement comprises an emitter for laser light, a detector for laser light and a LIDAR system.

FIG. 1B schematically illustrates the arrangement of FIG. 1A in greater detail, wherein an arrangement comprises a scanning device designed to scan the laser light.

FIG. 2 schematically illustrates a scanning device with a fiber-shaped element with a movable end according to different embodiments.

FIG. 3A schematically illustrates a scanning device with a fiber-shaped element with a movable end according to different embodiments, wherein FIG. 3A illustrates a curvature of the fiber-shaped element.

FIG. 3B schematically illustrates a scanning device with a fiber-shaped element with a movable end according to various embodiments, wherein FIG. 3B illustrates a torsion of the fiber-shaped element.

FIG. 4A schematically illustrates a scanning device with a fiber-shaped element with a movable end according to various embodiments.

FIG. 4B schematically illustrates a scanning device with a fiber-shaped element with a movable end according to various embodiments.

FIG. 4C schematically illustrates a scanning device with a fiber-shaped element with a movable end according to various embodiments.

FIG. 5 schematically illustrates a positioning device for determining a position of the movable end of the fiber-shaped element according to different embodiments, wherein the positioning device comprises a fiber Bragg grating.

FIG. 6A schematically illustrates a positioning device for determining a position of the movable end of the fiber-shaped element according to different embodiments, wherein the positioning device comprises two fiber Bragg gratings.

FIG. 6B schematically illustrates a positioning device for determining a position of the movable end of the fiber-shaped element according to different embodiments, wherein the positioning device comprises two fiber Bragg gratings.

FIG. 6C schematically illustrates a positioning device for determining a position of the movable end of the fiber-shaped element according to different embodiments, wherein the positioning device comprises four fiber Bragg gratings.

FIG. 7 schematically illustrates a positioning device for determining a position of the movable end of the fiber-shaped element according to different embodiments, wherein the positioning device comprises four fiber Bragg gratings.

FIG. 8A schematically illustrates a positioning device for determining a position of the movable end of the fiber-shaped element according to different embodiments, wherein the positioning device comprises four fiber Bragg gratings.

FIG. 8B schematically illustrates a positioning device for determining a position of the movable end of the fiber-shaped element according to different embodiments, wherein the positioning device comprises a beam splitter and a position-sensitive detector (PSD).

FIG. 8C schematically illustrates a positioning device for determining a position of the movable end of the fiber-shaped element according to different embodiments, wherein the positioning device comprises a beam splitter and a position-sensitive detector (PSD).

FIG. 8D schematically illustrates a positioning device for determining a position of the movable end of the fiber-shaped element according to different embodiments, wherein the positioning device comprises a beam splitter and a position-sensitive detector (PSD).

FIG. 9 schematically illustrates an actuator for moving the movable end of the fiber-shaped element according to various embodiments.

FIG. 10A schematically illustrates an actuator for moving the movable end of the fiber-shaped element according to various embodiments.

FIG. 10B schematically illustrates an actuator for moving the movable end d of the fiber-shaped element according to various embodiments.

FIG. 10C schematically illustrates an actuator for moving the movable end of the fiber-shaped element according to various embodiments.

FIG. 11 schematically illustrates an actuator for moving the movable end of the fiber-shaped element according to various embodiments.

FIG. 12 schematically illustrates an arrangement for carrying out a scanned distance measuring of objects in the surroundings of the arrangement according to various embodiments.

FIG. 13 is a flow chart of a method according to various embodiments.

FIG. 14 schematically illustrates a curvature mode of the first order and a curvature mode of the second order according to various embodiments.

FIG. 15 schematically illustrates a device according to various embodiments.

FIG. 16 schematically illustrates a device according to various embodiments.

FIG. 17 schematically illustrates a two-dimensional scanning range.

### DETAILED DESCRIPTION OF EMBODIMENTS

The above-described qualities, features and advantages of this invention and the type and manner how they are achieved will become clearer and more understandable in conjunction with the following description of the exemplary embodiments which are explained in detail in conjunction with the drawings.

The present invention is explained in detail in the following using preferred embodiments with reference being made to the drawings. In the figures the same reference numerals designate the same or similar elements. The figures are schematic representations of various embodiments of the invention. Elements shown in the figures are not necessarily shown true-to-scale but rather the various elements shown in the figures are reproduced in such a manner that their function and general purpose will become understandable to a person skilled in the art. Connections and couplings between functional units and elements shown in the figures can also be implemented as an indirect connection or coupling. Functional units can be implemented as hardware, software or a combination of hardware and software.

Different technologies for the scanning of light are described in the following. The following technologies can make possible, for example, the two-dimensional scanning of light or the one-dimensional scanning of light. The scanning can designate a repeated emitting of the light at different radiation angles. The scanning can designate the repeated scanning of different points in the surroundings by the light. E.g., the amount of the different points in the surroundings and/or the amount of the different radiation angles can determine a scanning range.

It is possible to scan laser light in different examples. For example, coherent or incoherent laser light can be used. It would be possible to use polarized or unpolarized laser light. For example, it would be possible that the laser light is used in a pulsed manner. For example, short laser pulses with pulse widths in the range of femtoseconds or picoseconds or nanoseconds are used. For example, a pulsed time can be in the range of 0.5-3 nanoseconds. The laser light can have a wavelength in the range of 700-1800 nm. For reasons of simplicity, reference will be made primarily to laser light in the following; however, the various examples described here can also be used for the scanning of light from other light sources, for example, broadband light sources or RGB light sources. RGB light sources designate here in general light sources in the visible spectrum, wherein the color space is covered by overlaying several different colors—for example, red, green, blue or cyan, magenta, yellow, black.

A movable end of a fiber-shaped element is used in various examples for scanning the laser light. The fiber-shaped element can be designed to be longitudinal and could also be designated, for example, as a beam. The fiber-shaped element can be designed to be straight, i.e., it has no or no significant curvature in a position of rest. The fiber-shaped element is designated in the following as fiber for reasons of simplicity.

For example, fibers can be used which have no core which conducts light. However, in other example light fibers are used which are also designated as glass fibers. However, it is not necessary here that the fibers are produced from glass. The fibers can be produced, for example, from plastic, glass or some other material. For example, the fibers can be produced from quartz glass or silicon. For example, the fibers can have a 70 GPa modulus of elasticity. For example, the fibers can make an expansion of material of up to 4% possible. In some examples the fibers have a core in which the introduced laser light is propagated and enclosed by total reflection on the edges (optical waveguide). However, the fiber does not have to have a core. In various examples so-called single mode fibers (Engl. single mode fibers) or multimode light fibers (Engl. multimode fibers) are used. The various fibers described here can have, for example, a circular cross-section. It would be possible, for example, that the various fibers described here have a diameter which is not less than 50 μm, optionally not <150 μm , furthermore optionally not <500 μm furthermore optionally not <1 mm. For example, the various fibers described here can be designed to be bent or curved, i.e., flexible. To this end, the material of the fibers described here can have a certain elasticity.

For example, the movable end of the fiber could be moved in one dimension or in two dimensions. For example, it would be possible that the movable end of the fiber is tilted relative to a fixing position of the fiber; this results in a curvature of the—initially straight—fiber. Alternatively or additionally, it would be possible that the movable end of the fiber is rotated along the fiber axis—i.e., the central fiber axis (torsion). The movement of the movable end of the fiber can bring it about that laser light is radiated at different angles. As a result, the surroundings can be scanned with the laser light. Depending on the strength of the movement of the movable end, differently large scanning ranges can be implemented.

It is possible in the various examples described here to implement a torsion of the movable end of the fiber alternatively to or in addition to a curvature of the movable end of the fiber.

In various examples described herein the fiber is used as an actuator for a deflection unit. The deflection unit can be rigidly or stationarily attached to the movable end of the fiber. E.g., the fiber could be attached to a rear side of the deflection unit, wherein the deflection of light takes place on the front side. However, the laser light can reach the deflection unit on another optical path than through the fiber. E.g., in a resting state of the fiber the optical path and a longitudinal axis of the fiber could enclose an angle in the range of 90°-270°, optionally in the range of 170°-190°, furthermore optionally about 180°. The fiber serves—in other words—not as an optical waveguide for the laser light on the way to the deflection unit. This can avoid a complicated and expensive coupling of the laser light into the fiber. Furthermore, laser light can be used, which has, for example, not only the spatial TEM00 mode but alternatively or additionally other modes. This can make it possible to use an especially small laser, for example, a laser diode.

For example, the deflection unit can be implemented as a prism or a mirror. For example, the mirror could be implemented as a wafer. For example, the mirror could have a thickness in the range of 0.05 μ-0.1 mm.

In general, such technologies for the scanning of light can be used in very different areas of application. Examples include endoscopes and RGB projectors and printers. LIDAR technologies can be used in different examples. The LIDAR technologies can be used in order to carry out a spatially resolved distance measuring of objects in the surroundings. For example, the LIDAR technology can comprise runtime measurements of the laser light between the movable end of the laser, the object and a detector.

Although various examples regarding LIDAR technologies are described, the present application is not limited to LIDAR technologies. For example, the aspects described herein regarding the scanning of the laser light by the movable end of the fiber can also be used for other applications. Examples comprise, for example, the projecting of image data in a projector—e.g. an RGB light source could be used here.

Various examples are based on the recognition that it can be desirable to carry out the scanning of the laser light with great accuracy as regards the radiation angle. For example, the spatial resolution of the distance measuring can be limited in the context of LIDAR technologies by an impreciseness of the radiation angle. Typically, a higher (lower) spatial resolution is achieved the more precisely (less precisely) the radiation angle of the laser light can be determined.

It is not necessary in various embodiments that certain radiation angles or positions of the movable end of the fiber can be implemented in a reproducible manner in various scanning positions. An interruption of the scanning process at certain positions of the movable end of the fiber is not necessary; a continuous step-and-shoot technique can be implemented instead of one step-and-shoot technique. Rather, a LIDAR measuring can be implemented at any radiation angles and interpolated by the corresponding information about the radiation angle, e.g., at a firmly given angle grating by a precise measuring of the position of the movable end of the fiber.

Various examples relate to a positioning device designed to emit a signal which is indicative of the radiation angle. That means that the positioning device could be designed to emit a signal which is indicative of the position of the movable end of the fiber. For example, it would be possible that applications which make use of the scanning of the laser light use the signal of the positioning device in order to achieve a greater accuracy. As a result of the positioning device, it is not necessary to repeatedly implement certain positions of the fiber end but rather the actual position of the movable fiber end and of the actual radiation angle can be measured. This reduces the complexity of the control of the actuator for the positioning of the movable fiber end. The actuator can be designed, e.g., to continuously move the movable end back and forth between two extreme positions—for example, in contrast to the so-called step-and-shoot approaches where the scanning process is interrupted in an intermediate position for the measuring. The actuator does not have to be designed to implement certain positions between the extreme positions in a resolved manner. The actuator can be designed, e.g., to constantly move the movable end of the fiber back and forth between two extreme positions at a substantially constant speed. In particular, the actuator can be designed so that during the moving of the movable fiber between two extreme positions no decrease of the speed to zero takes place at intermediate positions.

In some examples the positioning device can be designed to carry out an optical measuring. For example, the positioning device could be designed to optically measure the curvature and/or the torsion of the fiber. Alternatively or additionally, the positioning device could be designed to optically measure the radiation angle of the laser light, for example, based on the laser light itself and/or based on light of a light-emitting diode and/or based on another laser light of another laser light source. Such an optical measuring of the position can be in particular especially precise. Moreover, high scanning frequencies can be possible. This requires continuous step-and-shoot scanning techniques.

In some examples the positioning device can be designed to determine the position of the movable end of the fiber by a status measuring of the laser light in the area of the movable end of the fiber. In contrast to other indirect techniques—which, for example, take account of a status measuring of the actuator—an especially accurate determination of the angle at which the laser light is emitted can take place in this manner. Furthermore, an especially rapid determination of the angle at which the laser light is emitted can take place. The scanning frequency at which the positioning device emits the signal can be especially high.

In various examples the positioning device can be designed to determine the position of the movable end of the fiber by a status measuring of the fiber itself. In contrast to other indirect techniques—which take account, for example, of a status measuring of the actuator—an especially accurate determination of the angle at which the laser light is emitted can take place in this manner. Furthermore, an especially rapid determination of the angle at which the laser light is emitted can take place. The scanning frequency at which the positioning device emits the signal can be especially high.

In various examples the positioning device comprises a PSD. The PSD can be operated, e.g., based on the lateral photoelectric effect. To this end, for example, a PIN diode can be used. Alternatively or additionally, a discrete PSD could also be used. The latter could comprise, for example, several discrete image points, for example, in the form of a CCD sensor or of a CMOS sensor. It can be possible with the PSD to determine the current angle at which the laser light is radiated. In some examples a light-permeable PSD (Engl. translucent PSD) can be used to avoid damage.

In various examples the positioning device comprises at least one fiber Bragg grating. The fiber Bragg grating can correspond to a periodic modulation of the refraction index of a fiber core. The fiber Bragg grating can have a length in the range of 100 μm -1 mm. A periodicity of the fiber Bragg grating can be in the range of the wavelength of light. When light strikes the fiber Bragg grating, whose wavelength fulfills the Bragg relationship, a significant amount of the incident light can then be reflected. A conclusion can be made about a change of length of the fiber in the area of the fiber Bragg grating in that the amplitude of the reflected light is measured. For example, the change of length of the fiber in the area of the fiber Bragg grating can be produced by a curvature of the fiber based on the movement of the free end of the fiber. In order to evaluate the reflected light, a spectrometer can be used, for example. However, it would also be possible that in order to evaluate the reflected light a cut-off filter is used which comprises a band-pass filter in the area of a flank of the filter curve of the fiber Bragg grating. In this manner, different intensities behind the cut-off filter can be indicative of a change of the reflection on the fiber Bragg grating. Corresponding techniques are disclosed in DE 10 2009 014 478 B4, wherein the corresponding disclosed content is taken up here by a cross reference.

The actuator can be designed, e.g., to implement a resonant drive. That means that the actuator can be designed to resonantly stimulate the mass of the end of the fiber and of other element in this area—such as, for example, the deflection unit and/or lenses, etc. Basically, an inherent mode of the first order and/or one or more inherent modes of a higher order can be resonantly stimulated here. This concerns the curvature and/or the torsion of the fiber. However, it would also be possible that the actuator implements a non-resonant drive.

Different effects can be achieved with the techniques described here. For example, it can be possible to implement an arrangement which implements the scanning of laser light in an especially simple, robust manner and with little structural space. In particular in comparison to reference implementations which use a macroscopic scanning mirror—which is connected, e.g., at several suspension points to a fixing—, the movement of the free end of the fiber cam be implemented with simple structural parts and in an especially highly integrated manner. Moreover, a wear on a corresponding arrangement can be less strong during the course of the operation in comparison to traditional scanning mirrors.

An especially precise positioning of the movable end of the fiber can be carried out by the using of a positioning device—in particular with a PSD and/or a fiber Bragg grating. As a result, it can again be possible to ensure a high spatial resolution for applications such as, for example, the LIDAR technique, which fall back on the scanning of the laser light over the surroundings. The high spatial resolution can also be achieved for continuous step-and-shot approaches.

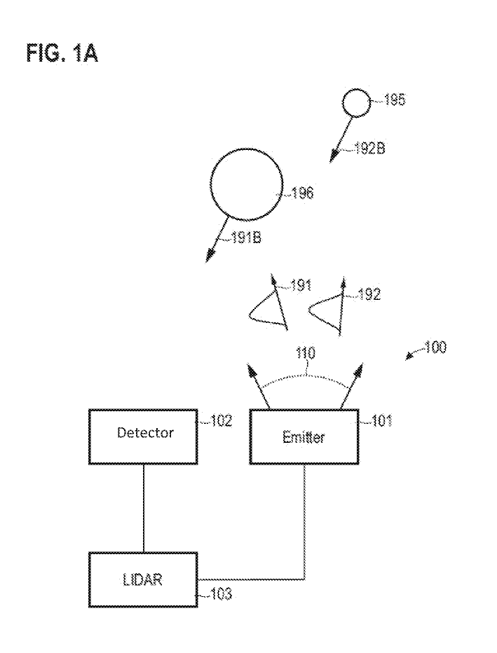

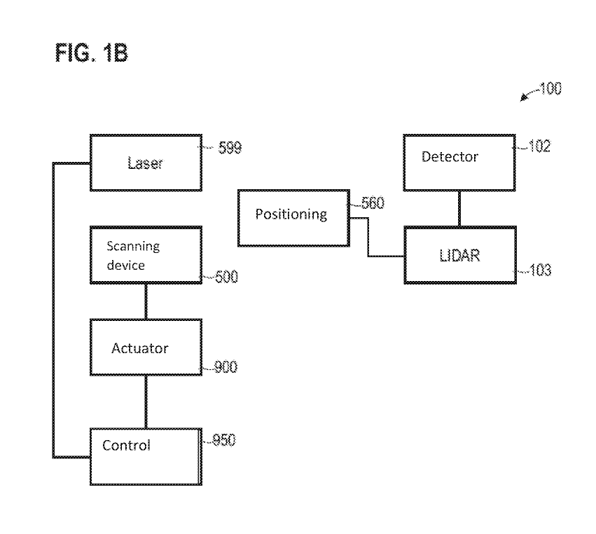

FIG. 1A illustrates aspects regarding a scanned distance measuring of objects 195, 196. In particular, FIG. 1A illustrates aspects regarding a distance measuring based on the LIDAR technology.

FIG. 1A shows an arrangement 100 comprising an emitter 101 for laser light 191, 192. The emitter 101 could be, e.g., a laser light source and/or an end of a light fiber which emits laser light. The laser light is emitted, for example, in a pulsed manner (primary radiation). For example, the primary laser light 191, 192 could be polarized. It could also be possible that the primary laser light 191, 192 is not polarized. The runtime of a laser light pulse between the emitter 101, an object 195, 196 and a detector 102 can be used to determine the distance between the arrangement 100 and the objects 195, 196. To this end, secondary radiation 191B, 192B reflected from the objects 195, 196 is measured. For example, a photodiode can be used as detector 102 which is coupled to a wavelength filter which allows light with the wavelengths of the laser light 191, 192 to selectively pass. As a result thereof, the secondary laser light 191B, 192B reflected by the objects 195, 196 can be detected.

It is basically possible that the emitter 101 and the detector 102 are implemented as separate structural parts; however, it would also be possible that the secondary laser light 191B, 192B is detected by the same lens which also implements the emitter 101.

The detector 102 can comprise, e.g., an avalanche photodiode. For example, the detector 102 can comprise a Single Photon Avalanche Diode (SPAD). For example, the detector can comprise a SPAD array comprising not less than 500, optionally not less than 1000, further optionally not less than 10000 SPADs. The detector 102 can be operated, e.g., by photon correlation. The detector 102 can be designed, e.g., for detecting individual photons.

A LIDAR system 103 is provided which is coupled to the emitter 101 and to the detector 102. For example, the LIDAR system can be designed to achieve a synchronization in time between the emitter 101 and the detector 102. The LIDAR system 103 can be designed to carry out the distance measuring of the objects 195, 196 based on measured signals which are obtained from the detector 102. For example, the LIDAR system 13 can be designed to emit a signal which is indicative for the distance and/or the positioning of the objects 195, 196 regarding the arrangement 100. In some examples the LIDAR system 103 can also emit a signal which is indicative for a speed of the objects 195, 196 and/or a material of the objects 195, 196. In addition, for example, the Doppler effect can be taken into consideration.

In addition, an optical frequency filter—for example a cut-off filter or a bandpass filter—could be used in the various examples whose filter curve is arranged in the spectrum range of the laser light. It can be achieved by the Doppler shift that the amount of light transmitted through the filter varies as a function of the speed of the object 195, 196. The speed can then be determined by an intensity measuring. For example, a reference measuring can be carried out in which no filtering is performed.

In order to be able to distinguish between the objects 195, 196—that is, in order to be able to make a spatial resolution available—the emitter 101 is designed to radiate the laser light 191, 192 at different angles 110 (radiation angles). Depending on the angle 110 adjusted, the laser light 191, 192 is reflected as a consequence either from the object 196 or from the object 195. Since the LIDAR system 103 contains information about the particular angle, the spatial resolution can be made available. In FIG. 1 the scanning range within which the angles 110 can be varied is illustrated with a dotted line.

FIG. 1B illustrates aspects regarding the arrangement 100. FIG. 1B illustrates the arrangement 100 in greater detail than FIG. 1A.

In the example of FIG. 1B the emitter 101 is implemented by a laser light source 599 and a scanning device 500. E.g., the laser light source 599 could be a fiber laser or a laser diode. The laser light source 599 could stimulate, e.g., several spatial modes. The laser light source 599 could have, for example, a frequency width of 5-15 nm.

The arrangement 100 also comprises an actuator 900 designed to actuate the scanning device 500. The scanning device 500 is designed to deflect the laser light 191, 192 emitted from the laser light source 599 so that it is radiated at different angles 110. The scanning device 500 can make possible a one-dimensional scanning or a two-dimensional scanning of the surroundings.

The actuator 900 can typically be electrically operated. The actuator 900 could comprise magnetic components and/or piezoelectric components. For example, the actuator could comprise a rotational magnetic field source designed to generate a magnetic field rotating as a function of time.

In order to control the actuator 900, a control 950—for example an electrical switch, a microcontroller, an FPGA, an ASIC and/or a processor, etc.—is provided which is designed to transmit control signals to the actuator 900. The control 950 is in particular designed to control the actuator 900 in such a manner that it actuates the scanning device for scanning a certain angular range 110. The control can implement a certain scanning frequency. For example, different spatial directions could be scanned with different scanning frequencies. Typical scanning frequencies can be in the range of 0.5 kHz-2.5 Hz, optionally in the range of 0.7 kHz-1.5 kHz. The scanning can take place continuously in a continuous step-and-shoot technique.

In addition, a positioning device 560 is provided in FIG. 1B. The positioning device 560 is designed to emit a signal which is indicative for the radiation angle at which the laser light 191, 192 is radiated. In addition, it would be possible, for example, that the positioning device 560 carries out the status measuring of the actuator 900 and/or of the scanning device 500. The positioning device 560 could also, for example, directly measure the primary laser light 191, 192. The positioning device 560 can generally optically measure the radiation angle, e.g., based on the primary light 191, 192 and/or light from a light-emitting diode. In a simple implementation the positioning device 560 could also receive control signals from the control 950 and determine the signal based on the control signals. Even combinations of the above techniques are possible.

The LIDAR system 103 can use the signal made available by the positioning device 560 for the scanned distance measuring of objects. The LIDAR system 103 is also coupled to the detector 102. Based on the signal of the positioning device 560 and based on the secondary laser light 191B, 192B detected by the detector 102, the LIDAR system 103 can then carry out the distance measuring of the objects 195, 196 in the surroundings of the arrangement 100. The LIDAR system 103 can implement the spatial resolution of the distance measuring, for example, based on the signal of the positioning device 560.

It would also be possible in an example that the positioning device 560 is connected to the control 950 of the actuator 900 (not shown in FIG. 1B). A control loop could then be implemented, wherein the scanning device 500 is regulated based on the signal of the positioning device 560. The control loop could be implemented in an analog and/or a digital manner. That means that the control 950 can control the actuator 900 based on the signal of the positioning device 560. A reproducible scanning of the surroundings can then be made possible. E.g., measured points of the LIDAR measuring can be detected repeatedly at the same radiation angles. This can make as especially simple evaluation possible.

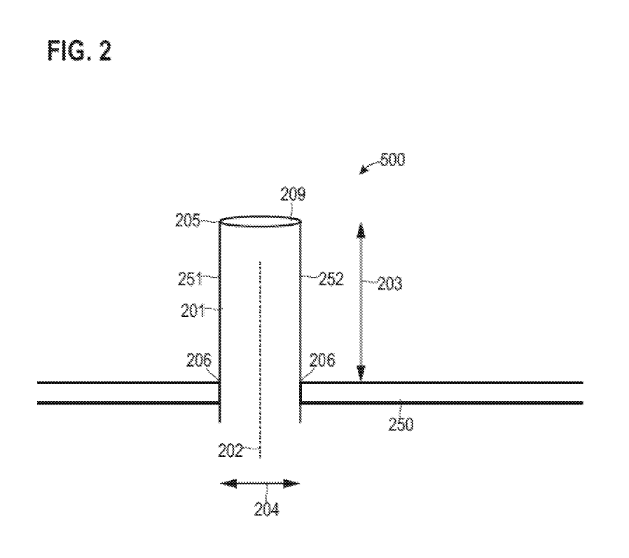

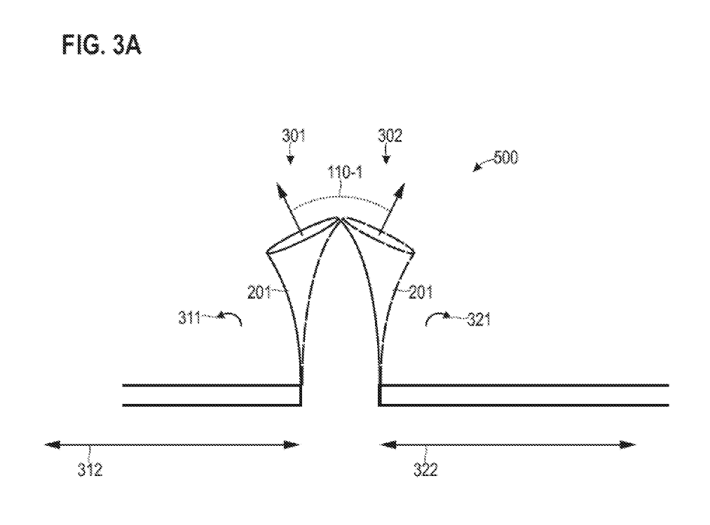

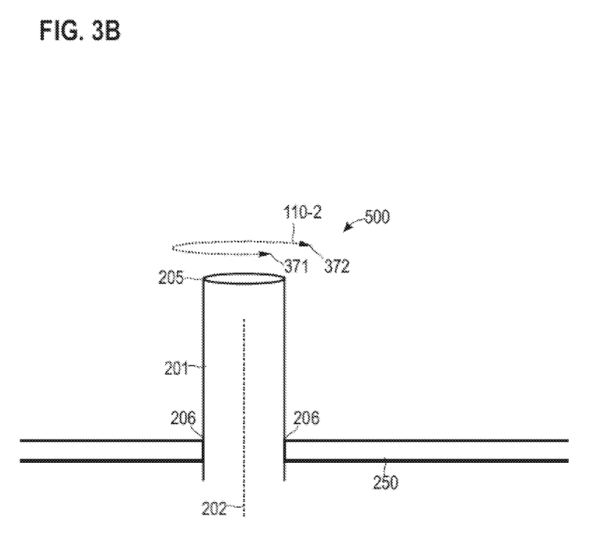

FIG. 2 illustrates aspects regarding the arrangement 100. In particular, FIG. 3 illustrates aspects regarding the scanning device 500. In the example of FIG. 2 the arrangement 100 comprises a fiber 201. The fiber 201 implements the scanning device 500. The fiber 201 extends along a central axis 202. The fiber 202 comprises a movable end 205 with an end surface 209.

The arrangement 100 also comprises a fixing 250. For example, the fixing 250 could be manufactured from plastic or metal. The fixing 250 could, for example, be part of a housing which receives the movable end 250 of the fiber 201. The housing could be, e.g., a DPAK or DPAK2 housing.

The fixing 250 fixes the fiber 201 to a fixing position 206. For example, the fixing 250 of the fiber 201 on the fixing position 206 could be implemented by a clamping connection and/or by a soldered connection and/or an adhesive connection. Therefore, in the area of the fixing position 206 the fiber 201 is stationarily or rigidly coupled to the fixing 250. The fiber 206 could also end at the fixing position 206, i.e., another end of the fiber 201 opposite the movable end 205 could coincide with the fixing position 206.

Furthermore, FIG. 2 shows a length 203 of the fiber 201 between the fixing position 206 and the movable end 205. In this area the fiber 201 is constructed to be straight. It is apparent from FIG. 2 that the movable end 205 is at a distance from the fixing position 206. For example, in various examples the length 203 could be in the range of 0.5 cm-10 cm, optionally in the range of 1 cm-5 cm, furthermore optionally in the range of 1.5-2.5 cm. For example, the length 203 could be in a range of 5 mm-10 mm. An especially large torsion angle can be achieved in particular in combination with the torsion of the fiber by such a dimensioning of the length 203 of the straight fiber 201.

Therefore, the movable end 205 stands freely in space. As a result of this distance of the movable end 205 opposite the fixing position 206, it can be achieved that the position of the movable end 205 of the fiber 201 opposite the fixing position 206 can be changed. It is possible here, for example, to curve and/or rotate the fiber 201 in the area between the fixing position 206 and the movable end 205. FIG. 2 shows a rest state of the fiber 201 without movement or deflection.

FIG. 3A illustrates aspects regarding the arrangement 100. In particular, FIG. 3A illustrates aspects regarding the scanning device 500. In the example of FIG. 3A, the arrangement 100 comprises a fiber 201. The fiber 201 implements the scanning device 500. The example of FIG. 3A corresponds to the example of FIG. 2. FIG. 3a shows a dynamic state of the scanning device 500.

In the example of FIG. 3A the end 205 of the fiber 201 is shown in a position 301 and a position 302 (dashed line in FIG. 3A). These positions 301, 302 implement extreme positions of the fiber 201: E.g., a stop could be provided which presents a further movement of the end 205 beyond the positions 301, 302 (not shown in FIG. 3A). The fiber 201 can move back and forth between the positions, 301, 302, e.g., periodically. In the example of FIG. 3A the position 301 corresponds to a curvature 311. The position 302 corresponds to a curvature 321. The curvatures 311, 321 have opposite signs. In order to move the fiber 201 between the positions 301, 302, the actuator 900 can be provided (the actuator 900 is not shown in FIG. 3A).

Whereas in FIG. 3A a one-dimensional movement (in the drawing plane of FIG. 3A) is shown, a two-dimensional movement (with a component vertical to the drawing plane of FIG. 3A) would also be possible. For example, a Lissajous figure can be implemented.

It can be achieved by making the curvatures 311, 321 available in the positions 301, 302 that the laser light 191, 192 is radiated over the curvature angle range 110-1. This makes it possible to scan the surrounding area of the arrangement 100 by the laser light 191, 192. The laser light 191, 192 does not have to run through the fiber 201 here; the primary laser light 191, 192 (not shown in FIG. 3A) can also reach the movable end 205 on another optical path.

The example of FIG. 3A also illustrates an exemplary radius of curvature 312 for the curvature 311. Furthermore, an exemplary radius of curvature 322 for the curvature 321 is illustrated. The radii of curvature 312, 322 are both approximately 1.5 times as large as the length 203 of the fiber 201 between the fixing position 206 and the movable end 205. In other examples even lesser curvatures 311, 321 or greater curvatures 311, 321 could also be implemented. Here, lesser curvatures 311, 321 correspond to greater radii of curvature 312, 322, and in particular as regards the length 203.

Various implementations are based on the recognition that a weighting between a large scan area and small curvatures 311, 321 can be desirable. On the one hand, small curvatures 311, 321 can be desirable regarding a scanning frequency and/or a material fatigue of the fiber 201. On the other hand, large curvatures 311, 321 can be desirable regarding a large scanning area.

It can be possible in many examples that the curvatures 311, 321 in the positions 301, 302 have different radii of curvature 312, 322 along the position along the axis 202 of the fiber 201. For example, it would be possible that close to (at a distance from) the end 205 of the fiber 201 (greater (lesser) radii of curvature 312, 322 are present in the positions 301, 302, or vice versa. For example, it would be possible that close to (at a distance from) the end 205 of the fiber, radii of curvature 312, 322 are present in the positions 301, 302 which have a positive (negative) radius of curvature 312, 322. In other words, it would be possible that the curvatures 311, 321 have a turning point. Such a design of the curvatures 311, 321 can be achieved, for example, by a suitable cooperation of the actuator 900 with the fiber 201. For example, an action of force of the actuator 900 could act on a point on the fiber 201 which is closer at the end 205 than is present at the fixing position 206 (or, however, is closer to the fixing position 206). For example, a curvature mode of the second order or of a higher order could be resonantly stimulated. It can be achieved with such techniques that an especially large scanning range can be scanned by the laser light 191, 192.

FIG. 3B illustrates aspects regarding the arrangement 100. In particular, FIG. 3B illustrates aspects regarding the scanning device 500. In the example of FIG. 3B the arrangement 100 comprises a fiber 201. The fiber 201 implements the scanning device 500. The example of FIG. 3B corresponds to the example of FIG. 2. FIG. 3B shows a dynamic state of the scanning device 500.

In the example of FIG. 3B the end 205 of the fiber 201 is moved in such a manner that the fiber 201 is moved in the area between the fixing position 206 and the movable end 205 between a first torsion 371 and a second torsion 372. This corresponds to a twisting of the fiber 201 along the central axis 202 the fiber retains its straight shape.

The making available of the torsions 371, 372 brings it about that the laser light 191, 192 (not shown in FIG. 3B) can be radiated over a corresponding torsion angle range 110-2, e.g. in conjunction with a deflection unit (not shown in FIG. 3B). This makes it possible to scan the surrounding area of the arrangement 100 by the laser light 191, 192 (not shown in FIG. 3B). The laser light 191, 192 does not have to run through the fiber 201 here: the primary laser light 191, 192 (not shown in FIG. 3A) can also reach the movable end 205 on another optical path.

A corresponding actuator can be provided again which is designed for implementing the various torsions 371, 372. For example, the torsions 371, 372 shown in FIG. 3B can correspond to extreme positions of the movable end 205. It would be possible, for example, that an appropriate stop is provided which prevents a further rotation of the movable end 205 past the torsions 371, 372 (not shown in FIG. 3B). Alternatively or additionally, it would also be possible that the actuator is designed to avoid a further rotation of the movable end 205 past the torsions 371, 372. Furthermore, FIG. 3B shows the angle range 110-2 which can be implemented, for example, in cooperation with a deflection unit (not shown in FIG. 3B) by the torsion 371, 372 of the movable end 205 of the fiber 201.

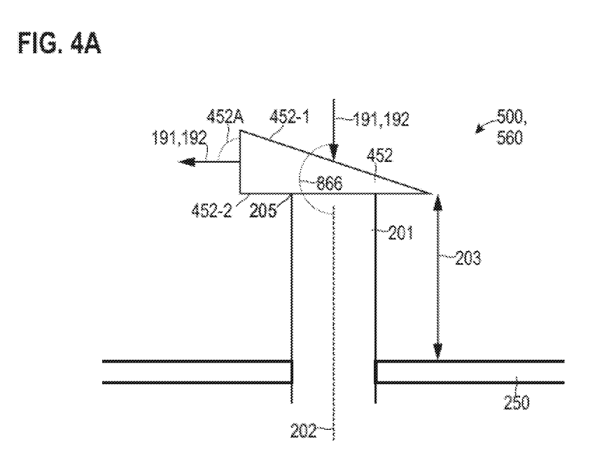

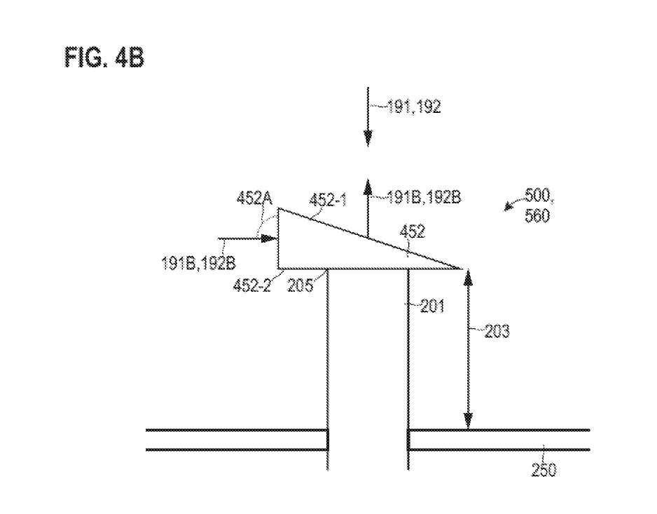

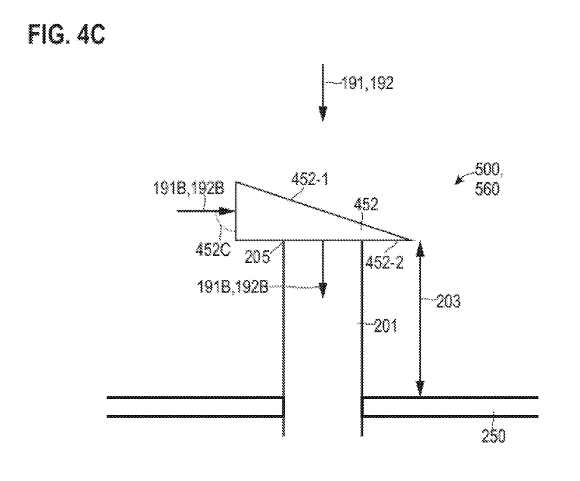

FIG. 4A illustrates aspects regarding the arrangement 100. In particular, FIG. 4A illustrates aspects regarding the scanning device 500. In the example of FIG. 4A the arrangement 100 comprises a fiber 201. The fiber 201 implements the scanning device 500.

The example of FIG. 4A illustrates in particular the beam path of the primary laser light 191, 192. In the example of FIG. 4A a deflection unit 452 is connected to the movable end 205 of the fiber 201. A movement of the fiber 201 therefore brings about a movement of the deflection unit 452. E.g., the deflection unit 452 can be tilted by a tilting 311, 321 of the fiber 201 and/or rotated by a torsion 371, 372 of the fiber 201. It is apparent from FIG. 4A that the beam path of the primary laser light 191, 192 and the central axis 202 of the fiber 202 enclose an angle 866 of about 180 degrees. The fiber 201 is fastened on the rear side 452-2 of the deflection unit 452 on the deflection unit 452 while the laser light 191, 192 strikes the front side 452-1. As a result of such a geometry, especially large scanning angles can be produced. In particular, it can be possible to transmit the primary laser light 191, 192 for example with a scanning angle in the range of >120 ° or even greater than 160 °.

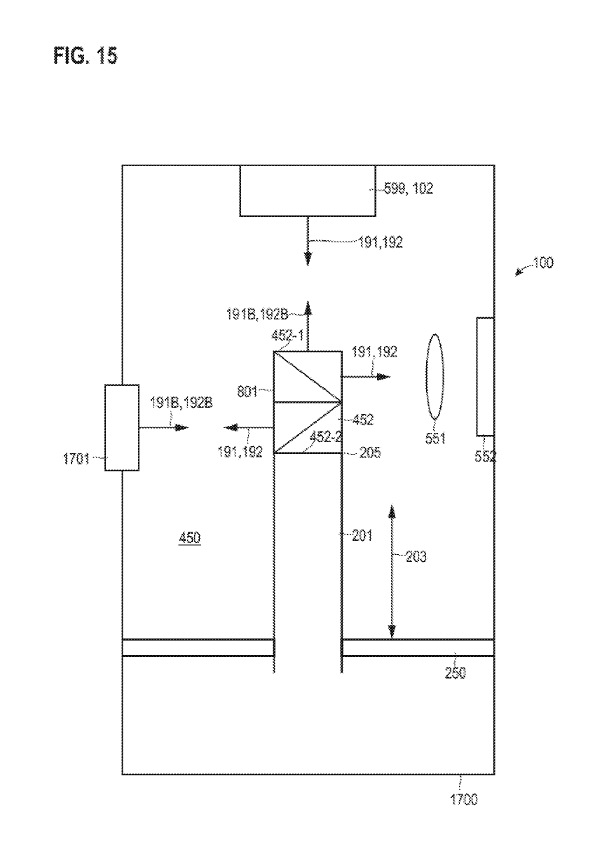

It is apparent from a comparison of the FIGS. 4A and 3B that the angle 866 remains constant upon torsion of the fiber 201. This is the case since the torsion axis is coincident with the central axis 202 of the fiber 201. This brings it about that the effective surface of the deflection unit which is available for deflecting the light 191, 192 displays no dependency on the torsion angle of the fiber 201. This has the advantage, in particular in a scenario in which the secondary light 191B, 192B is deflected according to the primary laser light 191, 192 (cf. FIG. 15), that the detector aperture is not reduced by larger scanning angles. Therefore, e.g. LIDAR measurements can be carried out with an especially large range. Sliding incidence is avoided.

The lateral dimension of the deflection unit 452 (left-right in FIG. 4A; i.e., vertically to the central axis 202 of the fiber 201) is significantly greater than the width of the fiber 201 vertically to the central axis 202, e.g., more than 1.5 times as great, or more than 2 times as great, or more than 4 times as great.

It would be possible in the various examples described here that a beam diameter of the primary laser light 191, 192 in the area of the deflection unit 451 is ca. 1.5 times as large as the diameter off the deflection unit 451, optionally more than 2.5 times as large, furthermore optionally more than 5 times as large. That means that the primary laser light 191, 192 can substantially illuminate the entire deflection unit 451 and not only a small point of the deflection unit 451. For example, a beam diameter of the primary laser light 191, 192 in the area of the deflection unit 451 could be in a range of 1-5 mm and be, e.g. ca. 3 mm

In the example of FIG. 4A, primary laser light 191, 192 is beamed on the deflection unit 452. The laser light 191, 192 does not run through the fiber 201 here. This avoids a complicated coupling in of the laser light 191, 192 which is associated with losses into an optical waveguide of the fiber 201 (to the extent it is present at all; not shown in FIG. 4A). an especially simple and economical construction is possible.

The deflection unit deflects the primary laser light 191, 192 by a deflection angle 452A. E.g., the deflection angle 452A could be about 90° or in a range between 45-135°, optionally in a range between 25°-155 °, furthermore optionally in a range of 5°-175 °.

In the example of FIG. 4A the deflection unit 452 is implemented by a prism. For example, the prism could be constructed to be especially small. For example, the prism could have a diameter of not more than 2 mm—this corresponds to the above-cited lateral dimension of the deflection unit 452. The prism could optionally have a diameter of not more than 1 mm This can bring it about that the fiber 201 can be moved in the area between the fixing position 206 and the movable end 205 without the inertia having to overcome an especially large mass of the deflection unit 452. In addition, high residence frequencies of the movement of the fiber 201 can be achieved. On the other hand the deflection unit 452 can be dimensioned to be sufficiently large to still be struck by the laser light 191, 192 even in the case of slight systematic changes of position—e.g. based on thermal expansion, gravity, etc.—opposite the laser light source 599. In addition, the deflection unit 452 can be struck by the laser beam even upon a movement of the movable end 205.

In other examples the deflection unit 452 could be constructed, e.g., by a mirror—for example a micromirror.

In the example of FIG. 4B the deflection unit 452 is connected only via the fiber 201 to the fixing 250—i.e., a 1-point coupling of the deflection unit 452 to the fixing 250 is implemented. In other examples the deflection unit s452 could be connected, e.g., by other fibers (not shown in FIG. 4B) or by a guide, etc. to the fixing 250. The connection of the deflection unit 452 only by the fiber 201 can make possible an especially high mobility of the deflection unit 452. This can make large scanning angles 110, 110-1, 110-2 possible.

FIG. 4B illustrates aspects regarding the arrangement 100. In particular, FIG. 4A illustrates aspects regarding the scanning device 500. In the example of FIG. 4B the arrangement 100 comprises one fiber 201. The fiber 201 implements the scanning device 500. The example of FIG. 4B illustrates in particular the beam path of the secondary laser light 191B, 192B.

In the example of FIG. 4B the secondary laser light 191B, 192B is deflected by a deflection angle 452B which corresponds to the deflection angle 452A. This can bring it about that the secondary laser light 191B, 192B takes the same optical path as the primary laser light 191, 192.

FIG. 4C illustrates aspects regarding the arrangement 100. In particular, FIG. 4A illustrates aspects regarding the scanning device 500. In the example of FIG. 4B the arrangement 100 comprises one fiber 201. The fiber 201 implements the scanning device 500. The example of FIG. 4C illustrates in particular the beam path of the secondary laser light 191B, 192B.

In the example of FIG. 4C, the deflection unit 452 also implements an optical element which feeds secondary laser light 191B, 192B into an optical waveguide of the fiber 201. For example, the deflection unit 452 can implement a circulator. This means that the secondary laser light 191B, 192B is deflected at a different deflection angle 452C than the primary laser light 191, 192. In particular, the circulator is designed to couple the secondary laser light 191B, 192B into an optical waveguide of the fiber 201. To this end, the primary laser light 191, 192 and the secondary laser light 191B, 192B is polarized. This makes possible a simple detection of the primary laser light 191, 192.

In another example an optical element for coupling in the secondary laser light 191B, 192B can be implemented as another deflection unit—for example, as another prism or another mirror. The other deflection unit 452 can be arranged, e.g., in the vicinity of the deflection unit 452. E.g., the other deflection unit can be arranged adjacent to the deflection unit 452. For example, the other deflection unit can be arranged between the movable end 205 of the fiber 201 and the deflection unit 452. This can bring it about that the secondary laser light 191B, 192B can be measured almost in direct reflection. This can bring about a high signal level.

Corresponding functionality could also be implemented by an optical element separate from the deflection unit 452.

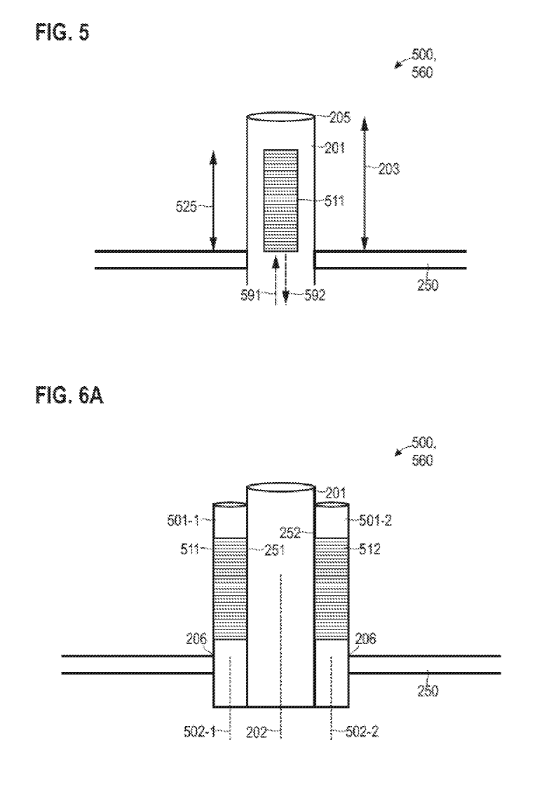

FIG. 5 illustrates aspects regarding the arrangement 100. In particular, FIG. 5 illustrates aspects regarding the positioning device 560. In the example of FIG. 5 the positioning device 560 is designed to measure the movement of the end 205 of the fiber 201. In particular, the positioning device 560 is designed to measure the curvature 311, 321 of the fiber 201. In particular, the positioning device 560 is designed to optically measure the curvature 311, 321 of the fiber 201.

To this end, incident light 591—e.g., with a different wavelength than the laser light 191, 192—is used. E.g., the light 591 can be made available by a broadband light source. The spectrum of the light 591 can have, e.g., a spectral width of not less than 50 nm, preferably of not less than 150 nm, especially preferably of not less than 500 nm. Reflected light 592—sometimes also designated as secondary radiation—is detected by a corresponding detector. The reflected light 592 is indicative for a curvature 311, 312 of the fiber 201 and therefore for the position 301, 302 of the end 205. Based on the reflected light 592, the signal can then be made available which is indicative for the curvature 311, 321 of the fiber 201. For example, this signal can be used by the LIDAR system 103. The radiation angle at which the laser light 191, 192 is radiated can be especially precisely determined by the optical measuring.

In the example of FIG. 5 the positioning device 560 is implemented by a fiber Bragg grating 511. The fiber Bragg grating 511 is implemented in an optical waveguide of the fiber 201. The fiber Bragg grating 511 has an extension parallel to the central axis 202 of the fiber 201; the refractive index of the material is periodically modulated along this extension. The fiber Bragg grating 511 is arranged in the fiber 201 between the fixing position 206 and the end 205. It can be achieved by a suitable arrangement of the fiber Bragg grating 511 in the fiber 201 that the curvature 311, 321 of the fiber 201 results in a longitudinal change of the fiber Bragg grating 511. E.g., the fiber Bragg grating 511 could be arranged at a distance from the central axis 202 of the fiber 201 (not shown in FIG. 5). This longitudinal change of the fiber Bragg grating 511 can result again in a change of the amplitude of the reflected light 592 in the range of the wavelengths which meet the Bragg condition. For this, the periodicity of the fiber Bragg grating 511 is coordinated with the wavelength of the light 591. The positioning device 560 can then be arranged to determine the signal based on an amplitude of the reflected light 592. In particular, it can be possible to determine the amplitude of the reflected light 592 especially precisely and/or especially rapidly. As a consequence, it can be possible to determine the curvature 311, 321 especially precisely. As a consequence, it can again be possible to determine the position of the end 205 and the angle 210 in the position especially precisely.

The fiber Bragg grating 511 has a length 525 which corresponds approximately to 80% of the length of the fiber 201 between the fixing position 206 and the end 205. It would be possible in other examples that the length 525 is at least 50% of the length 203, preferably at least 70%, and especially preferably at least 90%. The curvature 311, 321 can be especially precisely determined by such an expansion of the fiber Bragg grating 511 along the length 203.

It can be possible in some examples that the positioning device 560 comprises a cut-off filter. It can be possible to determine the amplitude of the reflected light 592 especially rapidly with the cut-off filter. For example, a transmission tip of the cut-off filter can be arranged in the area of a flank of the reflection curve of the fiber Bragg grating 511. As a result thereof, slight changes of length of the fiber Bragg grating 511 can lead to a strong variation of the amplitude let through the cut-off filter. As a consequence, the amplitude of the reflected light 592 can be precisely and rapidly determined. Rapid scanning frequencies with which the position of the end 205 is determined can be achieved. For example, it would be possible that the positioning device 560 is designed to update the signal with the scanning frequency of at least 500 Hz, preferably at least 1 kHz, especially preferably at least 1.5 kilohertz.

It would be possible in the various examples described herein that the positioning device 560 is designed to update the signal with the scanning frequency which is greater by at least a factor of 1.5 than the scanning frequency with which the actuator 900 moves the end 205 of the fiber 201, preferably at least by a factor of 2, especially preferably at least by a factor of 3. As a result thereof, a very precise determination of the angle 110 at which the laser light 191, 192 is radiated can take place. Continuous step-and-shoot techniques are made possible.

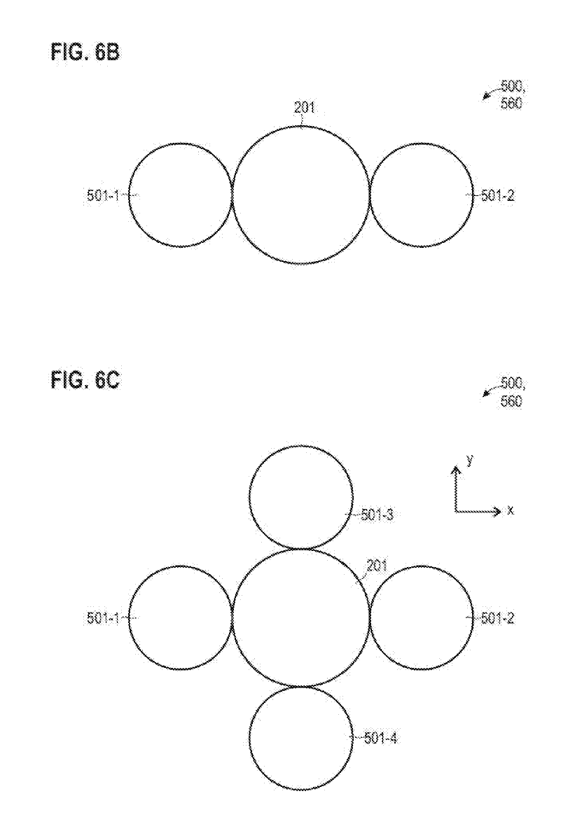

FIG. 6A illustrates aspects regarding the arrangement 100. In particular, FIG. 6A illustrates aspects regarding the positioning device 560. In the example of FIG. 6A the positioning device 560 is implemented by two fiber Bragg gratings 511, 512.

The fiber Bragg grating 511 is located in a fiber 501-1 which is different from the fiber 201, e.g., in a corresponding optical waveguide (not shown). The fiber Bragg grating 512 is located in a fiber 501-2 which is also different from the fiber 201, e.g. in a corresponding optical waveguide (not shown). In an example the fibers 501-1, 501-2 are attached to the fiber 201 on opposite sides 251, 252 of the fiber 201. In another example a multi-core fiber 201 could be used in order to implement different optical waveguides in which the fiber Bragg gratings 512 are arranged.

The central axes 502-1, 502-2 of the fibers 501-1, 501-2 run parallel to the central axis 202 of the fiber 201. As a result, a curvature 311, 321 of the fiber 201 generates a corresponding curvature of the fibers 501-1, 501-2. For example, the curvature 311 causes a compression of the fiber 501-1 in the counterclockwise direction (compare FIG. 3A) and with it a shortening of the fiber Bragg grating 511; the curvature 311 in the counterclockwise direction also causes an expansion of the fiber 501-2 and therefore a lengthening of the fiber Bragg grating 512. As a result of the eccentric arrangement of the fibers 501-1, 501-2 relative to the central axis 202, this shortening and lengthening of the fiber Bragg gratings 511, 512 can be especially significant. As a result, the position of the end 205 can be especially precisely determined based on light 592 reflected from the fibers 511, 512. Corresponding changes in length can also be observed upon a torsion 371, 372.

FIG. 6B illustrates aspects regarding the arrangement 100. In particular, FIG. 6B illustrates aspects regarding the positioning device 560. In the example of FIG. 6B the positioning device 560 is implemented by two fiber Bragg gratings 511, 512. The example of FIG. 6B here is a top view onto the example of FIG. 6A.

Again, it would be possible to use a multi-core fiber 201 in order to implement different optical waveguides in which the fiber Bragg gratings 512 are arranged.

FIG. 6C illustrates aspects regarding the arrangement 100. In particular, FIG. 6C illustrates aspects regarding the positioning device 560. In the example of FIG. 6C the positioning device 560 is implemented by four fiber Bragg gratings (not shown in FIG. 6C). The example of FIG. 6C corresponds basically to the example of the FIGS. 6A, 6B. However, in the example of FIG. 6C a greater number of fibers 501-1-501-4 with their own fiber Bragg gratings (not shown in FIG. 6C) are provided.

Again, it would be possible to use a multi-core fiber 201 in order to implement different optical waveguides in which the fiber Bragg gratings 512 are arranged.

In particular, movements of the end 205 can be detected in two dimensions (in the drawing plane of FIG. 6C) by the implementation of FIG. 6C. A two-dimensional scanning range can be monitored. For example, the fiber Bragg gratings in the fibers 501-1, 501-2 have a sensitivity to curvatures along the direction designated in FIG. 6C by x. For example, the fiber Bragg gratings in the fibers 501-3, 501-4 have a sensitivity for curvatures along the direction designated in FIG. 6C by y.

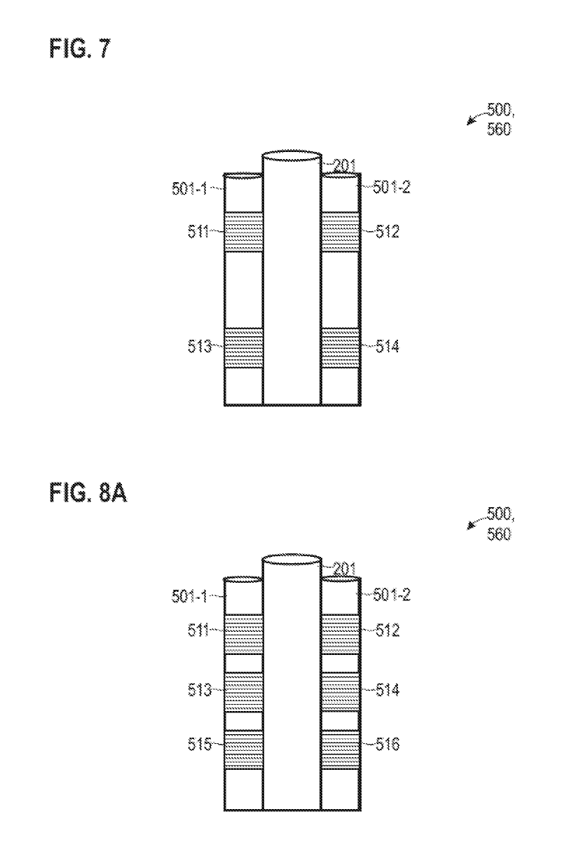

FIG. 7 illustrates aspects regarding the arrangement 100. In particular, FIG. 7 illustrates aspects regarding the positioning device 560. In the example of FIG. 7 the positioning device 560 is implemented by four fiber Bragg gratings 511-514.

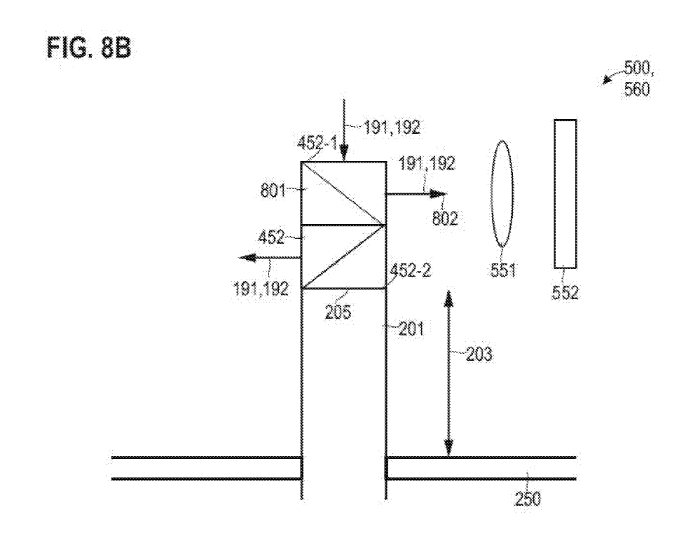

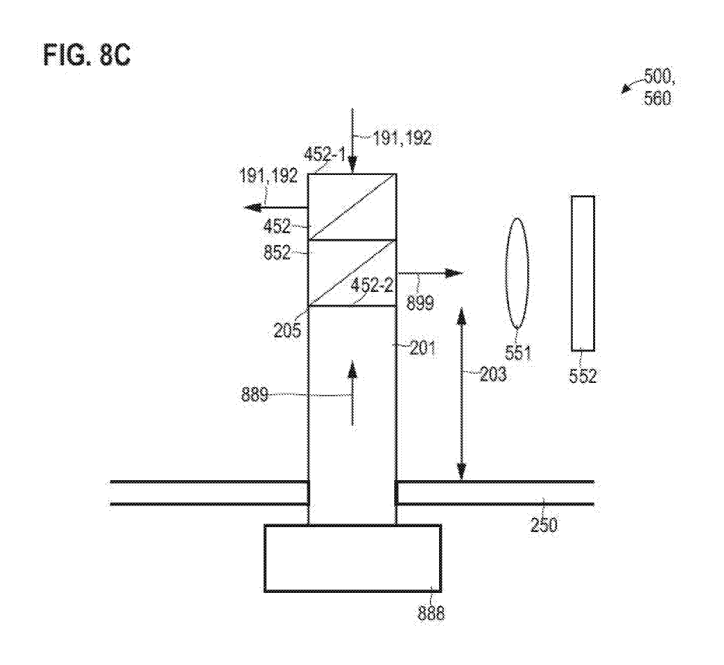

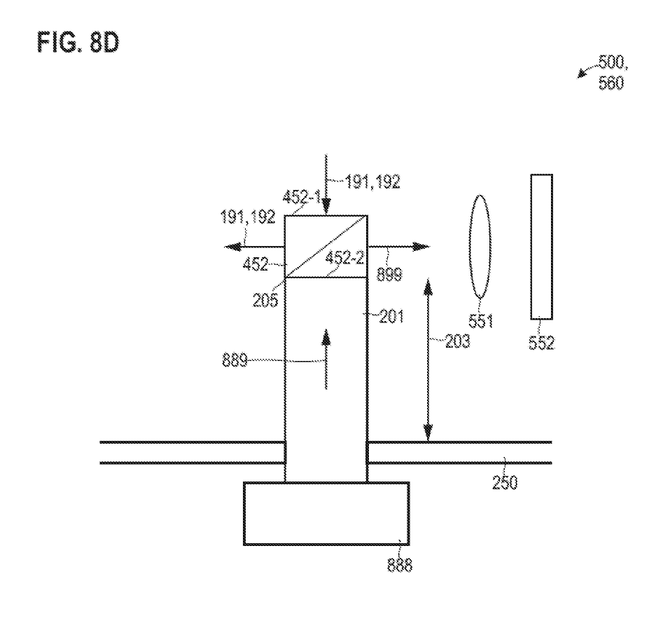

Again, it would be possible to use a multi-core fiber 201 to implement different optical waveguides in which the fiber Bragg gratings 512 are arranged. The fiber Bragg gratings 511, 513 are located in the fiber 501-1. The fiber Bragg gratings 512, 514 are located in the fiber 501-2. In some examples it would also be possible that more than two serially connected fiber Bragg gratings are located in the particular fibers 501-1, 501-2, 201 (cf. FIG. 8A).

The individual fiber Bragg gratings 511-514 can be individually controlled by using different grating constants for the particular serially connected fiber Bragg gratings 511-514. Light which has a sufficient bandwidth can be used for this.

An especially precise determination of the position of the end of the fiber 201 can take place by a comparison of the amplitudes of the light 592 reflected by the serially arranged fiber Bragg gratings 511, 513 and 512, 514 in particular for a case in which the radius of curvature can be changed as a function of the position along the length of the fiber 201. For example, it would be possible that the signal which is indicative for the position 301, 302 of the end 205 of the fiber 201 is determined by the positioning device 560, based on a difference of the amplitudes of the light 592 reflected by the serially arranged fiber Bragg gratings 511, 513 and 512, 514.

FIG. 8B illustrates aspects regarding the arrangement 100. In particular, FIG. 8B illustrates aspects regarding the positioning device 560. In the example of FIG. 8B the positioning device 560 is implemented by a PSD 552. The PSD 552 can be implemented isotropically or discretely. For example, the PSD 552 can comprise several image points or, e.g., a PIN diode.

In the example of FIG. 8B the device 100 comprises a beam splitter 801. The latter guides a part of the primary laser light 191, 192 in the direction of the PSD 552. The PSD 552 is designed to measure the primary laser light 191, 192. The PSD 552 measures the position of the primary laser light 191, 192 on its sensor surface. To this end a lens 551 is provided which focuses the primary laser light 191, 192 on the sensor surface of the PSD 552. The beam splitter 801 is stationarily connected to the end 205 of the fiber 201. The beam splitter 801 is designed to guide a partial beam path 802 of the primary laser light 191, 192 to the PSD 552.

It can be achieved by an appropriate arrangement of the PSD 552 regarding the movable end 205 that the position of the light spot on the sensor surface of the PSD 552 is indicative for the position of the movable end 205 of the fiber 201 and for the angle of emergence of the primary laser light 191, 192. Therefore, based on this measurement, the signal can be made available which is indicative for the position of the movable end 205 and in particular is indicative for the curvature 311, 321 and/or the torsion 371, 372 of the fiber 201 in the area between the fixing position 206 and the movable end 205. The signal can be indicative for the angle of emergence of the laser light 191, 192.

FIG. 8C illustrates aspects regarding the arrangement 100. In particular, FIG. 8C illustrates aspects regarding the positioning device 560. In the example of FIG. 8C the positioning device 560 is implemented by a PSD 552.

The example of FIG. 8C basically corresponds to the example of FIG. 8B. In the example of FIG. 8C, the primary laser light 191, 192 is not measured by the PSD 552. Rather, light 889 from a light-emitting diode 888 is used. In other examples, instead of a light-emitting diode 888 another light source could also be used, for example a light source which is also used for a fiber Bragg grating measuring with the previously described fiber Bragg gratings 511-516.

The light 889 runs through an optical waveguide of the fiber 201. In the example of FIG. 8C the light-emitting diode 888 is arranged on the fixed end of the fiber 201 and feeds the light 889 into the fiber 201. A deflection unit 852 is provided which deflects the light 889 in the direction of the PSD 552. Such an arrangement can make an especially simple lens possible in the area of the movable end 205.

In another example a part of the primary laser light 191, 192 can be branched off in the area of the laser light source 599 and conducted through the fiber 201. This branched-off laser light 191, 192 could then be conducted via the deflection unit 852 onto the PSD 552.

FIG. 8D illustrates aspects regarding the arrangement 100. In particular, FIG. 8C illustrates aspects regarding the positioning device 560. In the example of FIG. 8D the positioning device 560 is implemented by a PSD 552.

The example of FIG. 8D basically corresponds to the example of FIG. 8C. In the example of FIG. 8D the primary laser light 191, 192 as well as the light 889 are deflected by the deflection unit 452. The deflection unit 452 can comprise, e.g., a mirrored inner surface whose front side deflects the primary laser light 191, 192 and whose back side deflects the light 889. As a result thereof, an especially space-saving lens can be made available on the movable end 205.

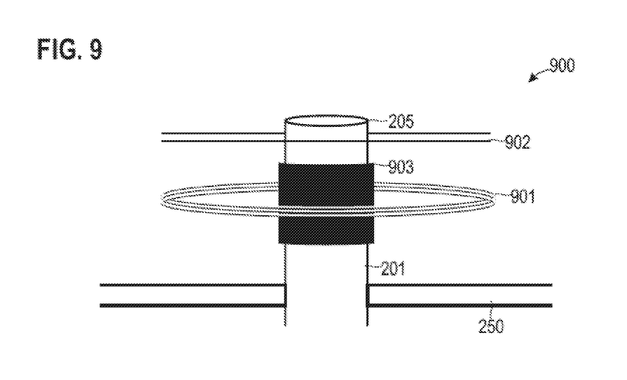

FIG. 9 illustrates aspects regarding the arrangement 100. In particular, FIG. 9 illustrates aspects regarding the actuator 900. In the example of FIG. 9 actuator 900 comprises a coil arrangement 901 which comprises conductor windings and is designed for generating a magnetic field in the area of the fiber 201. The fiber 201 is coated with a magnetic material 903, e.g., by sputtering. It would also be possible to adhere a magnet on or to solder it on, etc. The magnetic material is, e.g., ferromagnetic or paramagnetic or diamagnetic.

Furthermore, actuator 900 comprises a guide along which the end 205 is guided one-dimensionally. That means that the actuator 900 is designed according to the example of FIG. 9 to scan the fiber 205 one-dimensionally. A magnetic field variable in time can be generated in the area of the magnetic material 903 by using a current variable in time on the coil arrangement 901. This deflects the fiber 205 along the guide 902. The fiber 205 can be scanned in particular between the positions 301, 202.

It would be possible that the control is designed to control the actuator 900 in such a manner that it scans the end 205 of the fiber 201 between the reversal positions 301, 302 with a scanning frequency of at least 500 Hz, optionally of at least 700 Hz, furthermore optionally of at least 1.2 kHz. Scanning can mean in the different examples described herein that the control 950 repeatedly controls the actuator 900 in such a manner that it periodically brings about the movement of the end 205 for several repetitions.

However, it would also be possible in other examples that the actuator 900 is designed to scan the fiber 201 two-dimensionally. The guide 902 can then be eliminated.

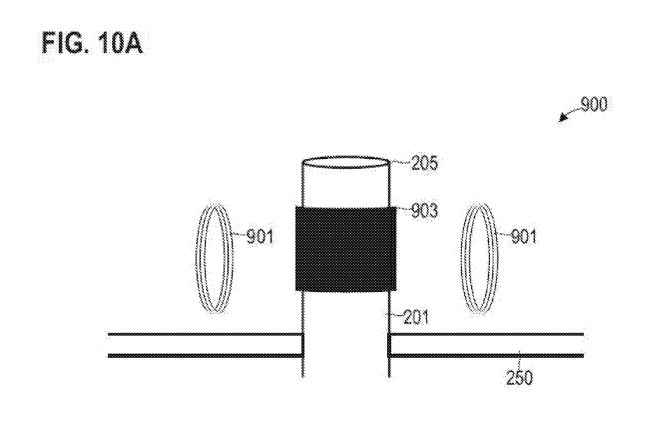

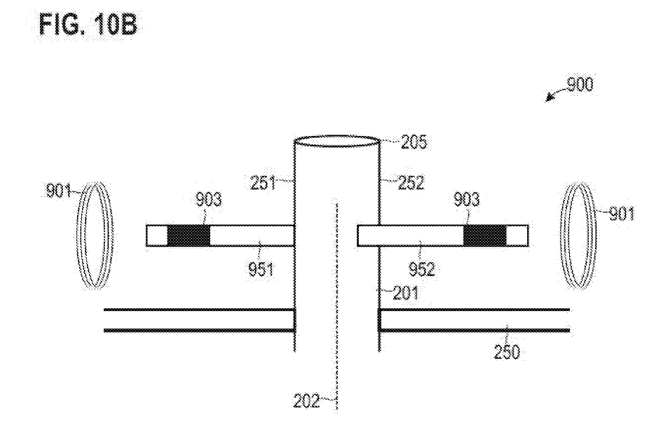

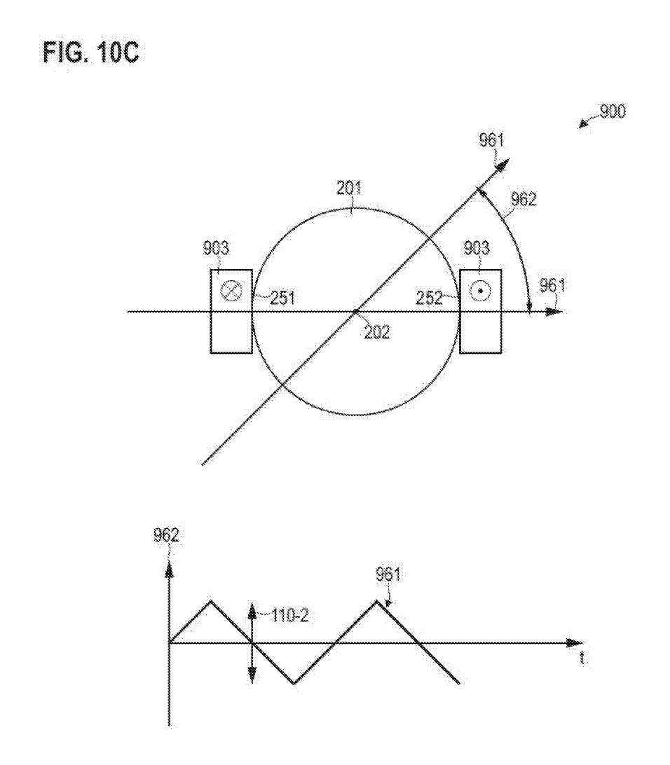

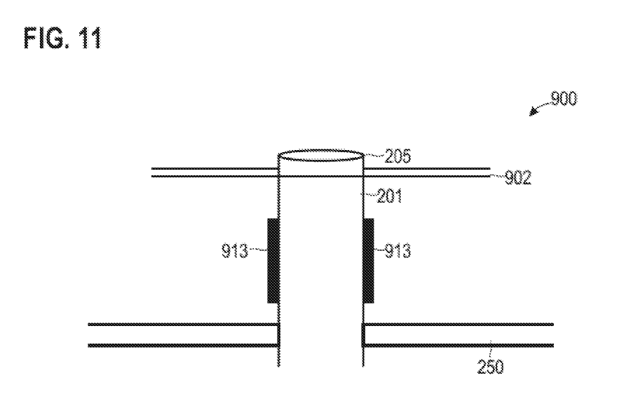

FIG. 10A illustrates aspects regarding the arrangement 100. In particular, FIG. 10A illustrates aspects regarding the actuator 900. In the example of FIG. 10A the actuator 902 comprises orthogonal coil pairs 901 (only one coil pair 901 is shown in FIG. 10A; the other orthogonal coil pair is arranged in a plane vertical to the plane of the drawing). A two-dimensional movement of the end 205 of the fiber 201 can be achieved by alternatingly supplying current to the orthogonal coil pairs 901.

FIG. 10B illustrates aspects regarding the arrangement 100. In particular, FIG. 10B illustrates aspects regarding the actuator 900. In the example of FIG. 10B the actuator 902 comprises levers 951, 952 attached to the opposite sides 251, 252 of the fiber 201. The levers 951, 952 extend vertically to the central axis 202 of the fiber 201. The levers 951, 952 could be manufactured, for example, from plastic, silicon, glass, etc. A magnet 903 is provided on each of the levers 951, 952 at a distance from the central axis 202. As a result thereof, an eccentric deflection of the levers 951, 952 relative to the central axis 202 into can take place by a magnetic field generated by the coils 901. As a result, a rotary movement can act on the fiber 201. This can bring about in particular a torsion of the fiber 201 in the area between the fixing position 206 and the movable end 205.

FIG. 10C illustrates aspects regarding the arrangement 100. In particular, FIG. 10C illustrates aspects regarding the actuator 900. In the example of FIG. 10C the actuator 900 comprises a rotary magnetic field source (not shown in FIG. 10C) which is designed for generating a magnetic field 961 which rotates as a function of the time in a plane defined vertically to the central axis 202 of the fiber 201 (plane of the drawing of FIG. 10C, top). An angle 962 is sketched in FIG. 10C which is assumed by the magnetic field 961 at any two points in time.

In the example of FIG. 10C the actuator 900 also comprises two magnets 903. The magnets 903 could be adhered onto the fiber 201. Sputtering would also be possible. The magnets 903 could be constructed as thin films. A first magnet 903 is arranged on the side 251 of the fiber 201. A second magnet 903 is arranged on the opposite side 252 of the fiber 201. The two magnets 903 have opposite polarities. In the example of FIG. 10C the magnetizing of the first magnet 903 (shown on the left in FIG. 10C) is oriented out of the drawing plane; the magnetizing of the second magnet 903 (shown on the right in FIG. 10C) is oriented into the drawing plane. Therefore, the magnetic field 961 causes oppositely oriented force effects in the plane vertical to the central axis 202 (drawing plane of FIG. 10C). This can bring about in particular a torsion of the fiber 201 in the area between the fixing position 206 and the movable end 205.

The scanning area can be adjusted by the dimensioning of the angle 962 on account of the torsion of the fiber 201. This is illustrated at the bottom in FIG. 10C. The course of the angle 962 of the rotary magnetic field 961 is shown as a function of time in FIG. 10C at the bottom. It is apparent from FIG. 10C that the angle 962 is periodically varied between maximum values. The torsion of the fiber 201 follows, for example, the angle 962 so that the angular range 110-2 defined by the torsion corresponds to the stroke of the angle 962.

For example, a system consisting of several coils whose coil axes enclose angles of, for example, 120° with each other can be used as a rotary magnetic field source. As a result, the rotary magnetic field can be produced by controlling the coils in a manner offset in time.

FIG. 11 illustrates aspects regarding the arrangement 100. In particular, FIG. 11 illustrates aspects regarding the actuator 900. In the example of FIG. 11 the actuator 902 comprises piezoelectrical conductors 913 attached to the different sides 251, 252 of the fiber 201. When a current flow is impressed by the piezoelectrical conductors 913 the latter change their lengths so that the curvature 311, 312 or the movement of the fiber 201 between the positions 301, 302 results.

Other arrangements of piezoelectrical conductors can be used.

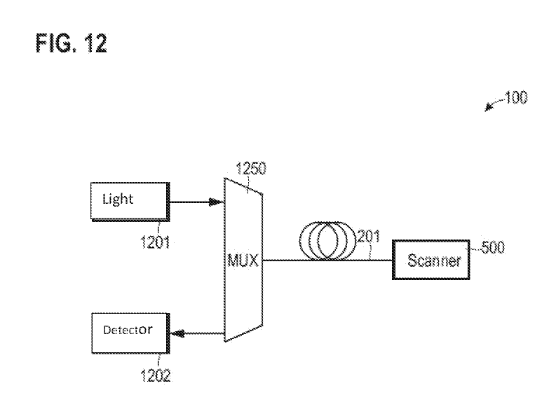

FIG. 12 illustrates aspects regarding the arrangement 100. In the example of FIG. 12 the arrangement 100 comprises the broadband light source 1201 generating the light 591 which has a wavelength coordinated with the grating periodicity of the one or of several fiber Bragg gratings 511-516 and comprises a detector 1202 which can detect the light 592 reflected by the one or the several fiber Bragg gratings. For example, the detector 1202 can comprise one or more cut-off filters. The arrangement 100 furthermore comprises a multiplexer 1250 which is designed to couple the light 591 of the broadband light source 1201 into an optical waveguide of the fiber 201. The multiplexer 1250 can also guide the light 592 reflected from the one or from the several fiber Bragg gratings to the detector 1202.

For example, the light source 1201 could also be used for a measurement on the PSD 552 (cf. FIG. 8D).

Whereas a scenario is shown in the example of FIG. 12 in which only the fiber 201 is present, examples with several dedicated fibers 501-1-501-4 for the fiber Bragg grating or the fiber Bragg gratings as discussed above are possible in a corresponding manner. Accordingly, the fiber 201 could also comprise several optical waveguides or cores (multicore fiber).

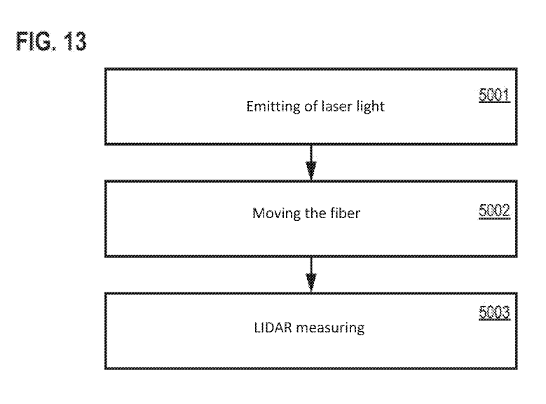

FIG. 13 is a flow chart of a method according to different examples. Primary laser light is transmitted in block 5001 in the direction of the deflection unit.

The first end of the fiber is moved in block 5002. Continuous step-and-shoot techniques can be used here. The movable first end of the fiber can be moved in such a manner here that a curvature and/or a torsion of the fiber is achieved in the area of the movable end. The movable first end of the fiber is rigidly connected to the deflection unit: As a consequence, the deflection unit is moved together with the movable end. As a consequence, the angle at which primary laser light is radiated can be changed. The primary laser light does not reach the deflection unit here through the fiber.

In block 5003 a LIDAR distance measuring based on the surroundings scanning implemented in block 5002 is optionally implemented by the primary laser light. The reflected secondary light is detected here, for example, through the same aperture or lens. Even applications such as the projecting of light or endoscopy could be used.

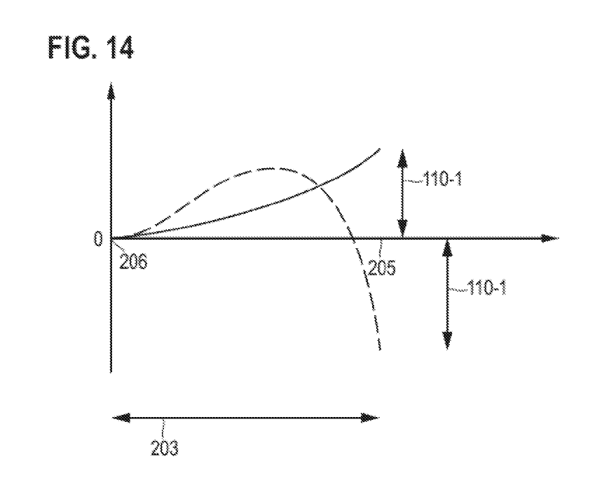

FIG. 14 illustrates aspects regarding the movement of the movable end 205 of the fiber 201. In the example of FIG. 14 the amplitude of the deflection of the fiber 201 is shown for different positions between the fixing position 206 and the movable end 205. In the example of FIG. 14 the amplitude of the deflection of the fiber 201 is shown for the eigenmode of the first order (solid line) and the eigenmode of the second order (dotted line). It is apparent from FIG. 14 that smaller curvature radii and therefore larger angles 110-1 at which the laser light 191, 192 is radiated can be implemented by the eigenmode of the second order. The eigenmode of the second order typically has a higher eigenfrequency than the eigenmode of the first order. In addition, it was observed that the material stressing of the material of the fiber 201 is less for the eigenmode of the second order than it is for the eigenmode of the first order. In particular, a lesser material stressing in conjunction with the eigenmode of the second order was able to be achieved in the area of the fixing position 206. Therefore, it is possible in some examples that the actuator 900 is designed to move the fiber 201 higher or lower in the eigenmode in a resonant manner.

FIG. 15 illustrates aspects regarding the arrangement 100. In the example of FIG. 15 the arrangement 100 comprises a housing 1700 which comprises a light-permeable element 1701. The laser light 191, 192 exiting from the movable end 205 of the fiber 201 can exit through the light-permeable element 1701—for example, a plastic pane or a glass pane. In some examples the light-permeable element 1701 could have a refractive power and therefore could implement a lens (not shown in FIG. 15). For example, the light-permeable element 1701 could be implemented by a lens. It would be possible by means of the lens to collect a divergent cross section of the beam of the laser light 191, 192 (the cross section of the beam of the laser light 191, 192 is not shown in FIG. 15). In particular, it can be achieved that the cross section of the beam of the laser light 191, 192 behind the lens does not significantly increase as a function of the location with increasing distance to the movable end 205. As a result, an especially high spatial resolution can be made available, for example in conjunction with the LIDAR technique. The laser light 191, 192 is radiated in small spatial angles.

In the example of FIG. 15 the area in which the movable end 205 of the fiber 201 moves is evacuated. That means that the space 450 between the light-permeable element 1701 and the fixing 250 is constructed to be airtight. As a result, the movement of the movable end 205 can be implemented without the friction of air. Furthermore, external disturbing influences can be avoided.

For example, the housing 1700 could comprise a passive temperature compensation. For example, the housing 1700 could comprise heat accumulators which can reduce strong fluctuations of temperature.

For example, the housing 1700 could comprise an active and/or passive shock damping. This could absorb or reduce in amplitude forceful shocks from outside of the arrangement 100 so that a negative influencing of the movement of the movable end 205 of the fiber 201 can be reduced.

In the example of FIG. 15 the laser light source 599 and the detector 102 are also arranged in the housing 1700. In other examples the laser light source 599 and/or the detector 102 could be arranged outside of the housing 1700. In such a case it would be possible that the housing 100 comprises an optical plug contact.

In the example of FIG. 15 the laser light source 599 and the detector 102 are arranged substantially opposite the fiber 201 in the housing 1700. That means that the angle between the optical path of the primary laser light 191, 192 to the deflection unit 452 and the central axis 202 of the fiber 201 in the rest position of the fiber 201 is about 180°. In other examples the laser light source 599 and/or the detector 102 could also be arranged differently regarding the fiber 201 in the housing 1700. For example, an angle between the optical path of the primary laser light 191, 192 to the deflection unit 452 and an angle with the central axis 202 of the fiber 201 in a rest position of the fiber 201—i.e. without deflection by the actuator—could be in the range of 25°-335°, optionally in the range of 90°-270°, furthermore optionally in the range of 120°-240°.

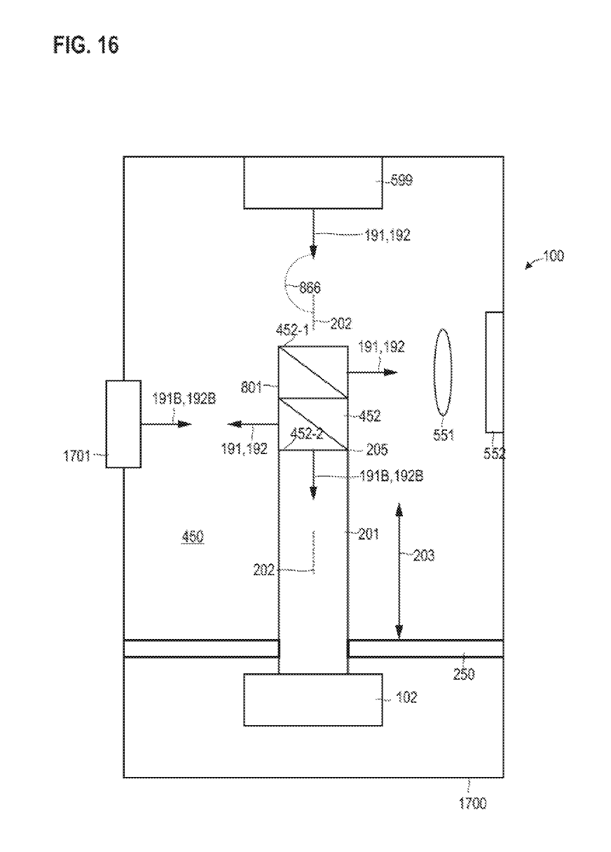

In the example of FIG. 15 the secondary laser light 191B, 192B is not coupled into an optical waveguide of the fiber 201. However, in other examples it would also be possible that the secondary laser light 191B, 192B is coupled into an optical waveguide of the fiber 201 (cf. FIG. 16.

The example of the FIGS. 15 and 16 can be combined with other examples described herein, e.g., with the example of the FIG. 8D: instead of the laser light 191, 192 even other light could be directed onto the PSD 552.

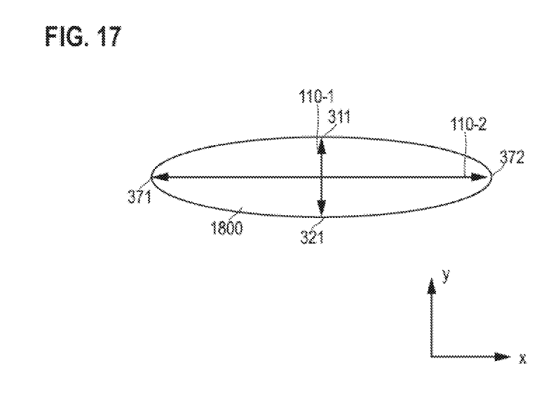

FIG. 17 illustrates aspects regarding the two-dimensional scanning of a surroundings area extending along two orthogonal spatial directions x,y. In the example of FIG. 17 a surroundings area 1800 is scanned which has a two-dimensional extension. The surroundings area 1800 can be obtained, e.g., by a Lissajous pattern from the superposing of two one-dimensional scanning procedures.

The torsional angle area 110-2 is achieved as a result by the torsion of the fiber 201 in the area between the fixing position 206 and the movable end 205. The torsional angle area 110-2 is greater than the curvature angle area 110-2 which is achieved by the curvature of the fiber 201. It was observed that especially good results can be achieved if the torsional angle area 110-2 is greater by at least a factor of 2 than the curvature angle area 110-1, optionally by at least a factor of 3.5, furthermore optionally by a factor of at least 5.

For example, the torsional angle 110-2 could be >90°, optionally >140°, furthermore optionally >170°. A smaller angle area 110-1 is achieved by the curvature of the fiber 201 in the area between the fixing position 206 and the movable end 205. For example, the curvature angle range 110-1 could be between 10° and 60°.

Such an implementation of the surroundings range 1800 is based on the recognition that an especially efficient scanning of large angle ranges 110-2 can be achieved based on the torsion of the fiber 201. At the same time, a two-dimensional scanning can be made possible by the combination with the curvature of the fiber 201.

Of course, the features of the embodiments and aspects of the invention previously described can be combined with each other. In particular, the features can be used not only in the described combinations but also in other combinations or by themselves without leaving the area of the invention.

Whereas the previous different examples were described regarding a LIDAR usage, it would also be possible in other examples to implement other applications. Examples comprise, e.g., a projector with an RGB light source, etc.

Whereas the previous different examples were described regarding magnetic actuators, it can also be possible in other examples to use other types of actuators, e.g., piezoelectrical actuators such as, for example, bending piezoactuators. The latter can be arranged in the area of the fixing position and designed, e.g., to bring about the torsion of the fiber.

1-15. (canceled)

16. A device comprising:
a flexible, fiber-shaped element with a first end and a second end,
a fixing which fixes the fiber-shaped element to a fixing position,
a deflection unit which is stationarily connected to the first end of the fiber-shaped element and is arranged for deflecting incident laser light,
at least one actuator which is designed to move the fiber-shaped element in the area between the fixing position and the first end, and
a laser light source which is designed to radiate primary laser light onto the deflection unit,
wherein an optical path of the primary laser light to the deflection unit does not run through the fiber-shaped element,
wherein an angle between the optical path of the primary laser light and a central axis of the fiber-shaped element is in the range of 120°-240°, in a rest position of the fiber-shaped element.

17. The device according to claim 16, wherein the angle between the optical path of the primary laser light and the central axis of the fiber-shaped element is 180° in the rest position of the fiber-shaped element.

18. The device according to claim 16,
wherein the deflection unit is designed to deflect the primary laser light by reflection on a front side of the deflection unit, and
wherein the first end of the fiber-shaped element is connected to a back side of the deflection unit which back side is opposite the front side.

19. The device according to claim 1, wherein the at least one actuator is designed to move the fiber-shaped element in the area between the fixing position and the first end between a first torsion and a second torsion.

20. The device according to claim 19, wherein the movement between the first torsion and the second torsion corresponds to a twisting of the fiber-shaped element along the central axis.

21. The device according to claim 1, wherein the at least one actuator is designed to move the fiber-shaped element in the area between the fixing position and the first end between a first curvature and a second curvature.

22. The device according to claim 21, wherein the at least one actuator is designed to move the fiber-shaped element between the first curvature and the second curvature in a resonant manner in an eigenmode of the second order or higher.

23. The device according to claim 1, further comprising:
a positioning device designed to emit a signal which is indicative for a radiating angle of the primary laser light from the arrangement,
wherein the positioning device is designed to optically measure the radiation angle.

24. The device according to claim 23,
wherein the positioning device comprises a position-sensitive detector, PSD, which is designed to measure the primary laser light,
wherein the positioning device furthermore comprises a beam splitter which is stationarily connected to the first end of the fiber-shaped element and which is designed to guide a partial beam path of the primary laser light to the PSD.

25. The device according to claim 1, wherein the fiber-shaped element implements a 1-point coupling of the deflection unit to the fixing.

26. The device according to claim 1, wherein the deflection unit is connected to the fixing only by the fiber-shaped element.

27. The device according to claim 1, wherein the fiber-shaped element is constructed to be straight between the fixing position and the first end in a rest position of the fiber-shaped element.

28. A device comprising:
a flexible, fiber-shaped element with a movable end,
a deflection unit which is stationarily connected to the first end of the fiber-shaped element and which is arranged for deflecting incident laser light),
at least one actuator which is designed to move the movable end of the fiber-shaped element opposite a fixing,
a laser light source which is designed to radiate primary laser light onto the deflection unit,
wherein an angle between an optical path of the primary laser light and a central axis of the fiber-shaped element is in the range of 120°-240°, in a rest position of the fiber-shaped element.

29. The device according to claim 28, further comprising a LIDAR system which is designed to carry out a scanned distance measurement of objects in the surroundings of the arrangement based on the primary laser light.

30. A method comprising:
moving a fiber-shaped element in a range between a fixing position of the fiber-shaped element on a fixing and a first end of the fiber-shaped element, wherein a deflection unit is stationarily connected to the first end of the fiber-shaped element, and
radiating the deflection unit with primary laser light, wherein the optical path of the laser light does not run through the fiber-shaped element,
wherein an angle between the optical path of the primary laser light and a central axis of the fiber-shaped is in the range of 120°-240° in a rest position of the fiber-shaped element.
